(19) United States
(12) Patent Application Publication
(10) Pub. No.: US 2025/0094210 A1
(43) Pub. Date: Mar. 20, 2025

(54) Processing Transaction Data At Different Levels Of Granularity

(71) Applicant: Oracle International Corporation, Redwood Shores, CA (US)

(72) Inventors: Rondy C. Ng, Redwood Shores, CA (US); Shyam Sundar Santhanam, Dublin, CA (US); Sundar Narayanan, Belmont, CA (US)

(73) Assignee: Oracle International Corporation, Redwood Shores, CA (US)

(21) Appl. No.: 18/632,055

(22) Filed: Apr. 10, 2024

Related U.S. Application Data
(60) Provisional application No. 63/583,253, filed on Sep. 16, 2023.

(51) Int. Cl. G06F 9/46

(52) U.S. Cl. CPC G06F 9/466

(57) ABSTRACT

A system accesses transaction data associated with a plurality of transactions, and based on characteristics of the transaction data, determines a set of functions to be applied to the transaction data at different corresponding levels of granularity. Determining the set of functions includes determining parallel processing requirements corresponding to the set of functions and determining an execution order corresponding to the set of functions based on the parallel processing requirements. The system schedules parallel execution of (a) a first function on the transaction data at a first level of granularity to generate a first dataset having the first level of granularity, and (b) a second function on the transaction data at a second level of granularity to generate a second dataset having the second level of granularity.

### BENEFIT CLAIMS; RELATED APPLICATIONS; INCORPORATION BY REFERENCE

Each of the following applications are hereby incorporated by reference: Application No. 63/583,253 filed on Sep. 16, 2023. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to processing transaction data.

### BACKGROUND

Transaction data may be received and processed at different levels of granularity for different purposes. Technical operations across various industries utilize transaction data for various purposes. Prior to use, the transaction data is subject to processing operations, such as capturing, organizing, and recording the transaction data. The transaction data serves as a valuable resource for generating insights, conducting analysis, executing technical operations, and facilitating automated or operational decision-making processes. Efficient processing of transaction data contributes to data integrity, facilitates real-time technical operations, and supports scalable technical operations.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for processing transaction data in accordance with one or more embodiments;

FIG. 3 illustrates an example implementation in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. TRANSACTION DATA PROCESSING SYSTEM ARCHITECTURE
3. DETERMINING FUNCTIONS FOR PROCESSING TRANSACTION DATA
4. EXAMPLE EMBODIMENT
5. COMPUTER NETWORKS AND CLOUD NETWORKS
6. MICROSERVICE APPLICATIONS
7. HARDWARE OVERVIEW
8. MISCELLANEOUS; EXTENSIONS

### 1. General Overview

One or more embodiments process transaction data in parallel and at different levels of granularity that correspond to different intended uses of the transaction data. A system processes the transaction data by executing a set of functions on the transaction data. Different functions require different levels of granularity of input data. Accordingly, the system generates sets of transaction data that have different levels of granularity from a base set of transaction data. The system determines the parallel processing requirements for the sets of transaction data.

In one or more embodiments, a set of functions applied to transaction data can include aggregating the transaction data based on different aggregation criteria corresponding to different levels of granularity. The different levels of granularity of the datasets allow the transaction data to be utilized in different technical processes. For example, a transaction monitoring application may display for a user a set of transaction characteristics. Accordingly, the system applies one set of aggregation criteria to generate a data set at one level of granularity to transmit to the transaction monitoring application. A machine learning model may ingest transaction data at another level of granularity. Accordingly, the system applies another set of aggregation criteria to generate another data set at another level of granularity. The system transmits the latter data set to a machine learning engine to train or re-train a machine learning model to generate predictions about the system in which the transactions are occurring.

In one example, the transaction data is concurrently utilized in different technical processes that require a different level of granularity. The different technical processes may operate in concert with one another. Additionally, the operations of the different technical processes may depend on having the latest transaction data at the required level of granularity concurrently with the other technical processes. For example, if a first technical process operates based on outdated transaction data, not only might the first technical process may generate inaccurate outputs, but the first technical process might also introduce inaccuracies into a second technical processes that depends on the outputs of the first technical process.

One or more embodiments process large volumes of transaction data to generate the datasets at the different levels of granularity. Technical operations may utilize the datasets in real-time operating environments and/or in contexts that have near-term deadlines. A system may currently subject the transaction data to different workflows that correspond to different target uses of the transaction data. The system may apply the workflows to the transaction data at different levels of granularity. To apply a workflow to the transaction data, the system determines a set of functions that correspond to the workflow. The set of functions may depend on the characteristics of the transaction data and/or the workflow to be applied to the transaction data. For example, the transaction data may be received from different sources at different levels of granularity, and the set of functions may depend on the level of granularity of the transaction data. Additionally, or alternatively, a workflow may be applied to the transaction data at different levels of granularity to generate processed datasets that respectively have different levels of granularity. Further, different sets of functions correspond to different workflow.

One or more embodiments process transaction data in parallel to generate data sets of different granularities. Similarly, the system performs downstream functions on the data sets of different granularities in parallel. The large volume of transaction data, combined with short timelines for executing the functions upon the transaction data gives rise to parallel processing requirements. Additionally, or alternatively, parallel processing requirements may arise from dependencies between operations executed on the datasets at the different levels of granularity. The parallel processing requirement may depend on characteristics of the transaction data and/or an intended use of the transaction data. In one example, the system processes the transaction data utilizing parallel processing operations to generate a plurality of processed datasets at different levels of granularity that are reconcilable to the same set of transaction data, while accommodating short timelines and limited processing resources. Additionally, or alternatively, the system generates target data structures corresponding the different levels of granularity associated with different technical processes that generate outputs based on the processed datasets. The system executes parallel processing operations to contemporaneously generate processed datasets that have different levels of granularity and stores the processed datasets according to the target data structures. The different technical processes then perform different technical operations using the respective processed datasets that are reconcilable to the same set of transaction data, thereby providing consistent outputs from the technical processes.

In one example, a system determines, a workflow to be applied to the transaction data and different levels of granularity for applying the workflow to the transaction data to generate processed datasets from the transaction data that have different levels of granularity. Based on the workflow and/or characteristics of the transaction data, the system determines a set of functions to be applied to the transaction data at the different corresponding levels of granularity. The system determines the parallel processing requirements corresponding to the set of functions and an execution order for the set of functions based on the parallel processing requirements. Upon having determined the parallel processing requirements and the execution order, the system schedules parallel execution of the different functions at the different levels of granularity. In one example, the system executes a first set of functions on the transaction data at a first level of granularity to generate a first dataset corresponding to the first level of granularity. Additionally, the system executes a second set of functions on the transaction data at a second level of granularity to generate a second dataset corresponding to the second level of granularity.

One or more embodiments described in this Specification and/or recited in the claims may not be included in this General Overview section.

### 2. Transaction Data Processing System Architecture

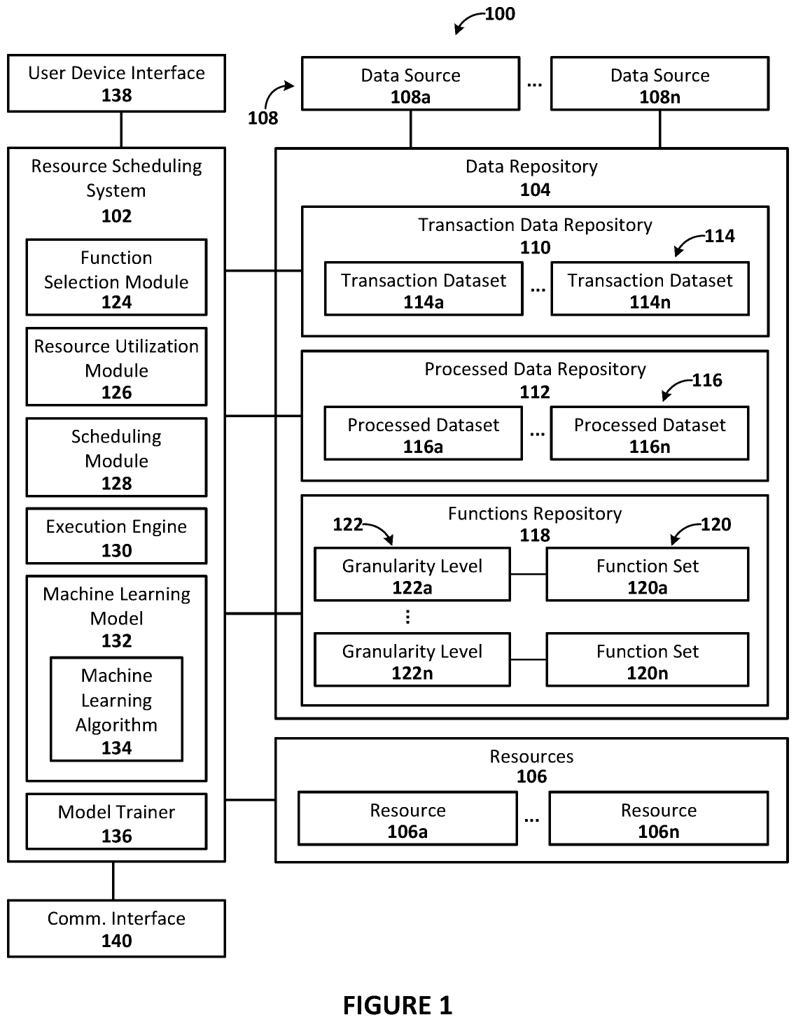

FIG. 1 illustrates a system 100 for transaction data processing in accordance with one or more embodiments. As illustrated in FIG. 1, system 100 includes a resource scheduling system 102 and a set of one or more data repositories 104. Additionally, the system 100 may include a set of resources 106 (e.g., resource 106a and resource 106n) for executing functions on data stored in the one or more data repositories 104. Utilization of the resources 106 may be coordinated by the resource scheduling system 102. Transaction data from one or more data sources 108 (e.g., data source 108a and data source 108n) is received and stored in the data repository 104. One or more data sources 108 may represent a portion of the system 100. Additionally, or alternatively, the system 100 may receive transaction data from one or more data sources 108 that are external to the system 100. The resource scheduling system 102 schedules the resources 106 to process the transaction data at different levels of granularity that correspond to different workflows associated with different intended uses of the transaction data. The resources 106 may include computing resources, such as virtual machines, compute instances, data processing services, networking services, data transfer services, serverless computing services, or other cloud resources, as well as combinations of these. The resources 106 may aggregate transaction data to generate processed datasets that have a lower level of granularity than the transaction data. Additionally, or alternatively, the resources 106 may disaggregate transaction data to generate processed datasets that have a higher level of granularity than the transaction data.

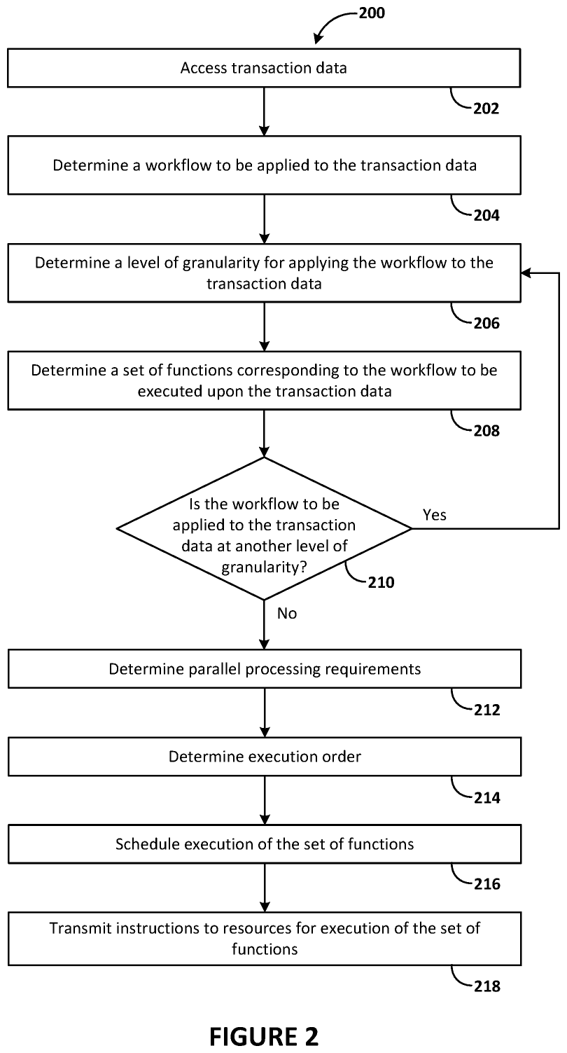

In one or more embodiments, the resource scheduling system 102 refers to hardware and/or software configured to perform operations described herein. Examples of operations are described below with reference to FIG. 2.

In one example, the resource scheduling system 102 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a browser device.

In one or more embodiments, the system 100 may include more or fewer components than the components described with reference to FIG. 1. The components described with reference to FIG. 1 may be local to or remote from each other. The components described with reference to FIG. 1 may be implemented in software and/or hardware. The components of system 100 may be distributed over multiple applications and/or machines. Multiple components may be combined into one application and/or machine. Operations described with respect to one component may instead be performed by another component. Additional embodiments and/or examples relating to computer networks are described below in Section 5, titled “Computer Networks and Cloud Networks.”

### A. Example Data Repositories.

The data repository 104 may include a transaction data repository 110 and a processed data repository 112. The transaction data repository 110 may include transaction data received from the one or more data sources 108. The transaction data may be stored in the transaction data repository 110 prior to being processed by the resources 106. In one example, the system 100 receives transaction data in real-time. The system 100 may receive the transaction data at a uniform level of granularity or at different levels of granularity. The transaction data may be stored in the transaction data repository 110 as one or more transaction datasets 114. For example, as shown in FIG. 1, the transaction data repository 110 includes transaction dataset 114a and transaction dataset 114n. The transaction datasets 114 may represent discrete sets of transaction data and/or a stream of transaction data. The processed data repository 112 may include processed data resulting from utilizing one or more resources 106 to process the transaction data. The resources 106 may process the transaction data by executing functions upon the transaction data at different levels of granularity to generate processed datasets that have different levels of granularity. The processed data may be stored in the processed data repository 112 as one or more processed datasets 116. For example, as shown in FIG. 1, the processed data repository 112 includes processed dataset 116a and processed dataset 116n. The processed data may include one or more processed datasets 116 resulting from executing different sets of functions on the transaction data, for example, at different levels of granularity.

As used herein, the term “granularity” refers to a level of detail or specificity contained within a dataset. The level of granularity of a dataset may reflect how finely the dataset is divided or categorized. Additionally, or alternatively, the level of granularity of a dataset may reflect one or more basis of categorization of a dataset. A level of granularity for transaction data may reflect a level of detail or specificity corresponding to particular transactions and/or one or more basis of categorization of the transactions. In one example, one transaction record may include features A-C. Another may include features A and B and may omit feature C. Yet another may include feature B and omit features A and C.

Transaction data may include data that is event-based, time-based, spatially-based, and/or category-based. Event-based transaction data includes data corresponding to discrete events or sets of events. A level of granularity of event-based transaction data may reflect at least one of: a number of events represented by a particular data element, a level of detail or specificity corresponding to particular data elements and/or one or more basis of categorization of the data elements. Time-based transaction data includes data corresponding to discrete points in time or periods of time. A level of granularity of time-based transaction data may reflect at least one of: a number of discrete points in time represented by a particular data element, a duration of a period of time represented by a particular data element, a level of detail or specificity corresponding to particular data elements and/or one or more basis of categorization of the data elements. Spatially-based transaction data includes data corresponding to discrete points in space or regions of space. A level of granularity of spatially-based transaction data may reflect at least one of: a number of discrete points in space represented by a particular data element, a size of a region of space represented by a particular data element, a level of detail or specificity corresponding to particular data elements and/or one or more basis of categorization of the data elements. Category-based transaction data includes data corresponding to discrete categories of items or sets of items grouped by category. A level of granularity of category-based transaction data may reflect at least one of: a number of discrete categories represented by a particular data element, a category breadth represented by a particular data element, a level of detail or specificity corresponding to particular data elements and/or one or more basis of categorization of the data elements.

In one example, processed dataset 116a is generated by utilizing one or more resources 106 to execute a first set of functions on a transaction dataset 114 at a first level of granularity, and processed dataset 116n is generated by utilizing one or more resources 106 to execute a second set of functions on the transaction dataset 114 at a second level of granularity. Additionally, or alternatively, the processed datasets 116 may include processed data resulting from one or more intermediate or subsequent sets of functions. In one example, processed dataset 116a is generated by utilizing one or more resources 106 to execute a first set of functions on a transaction dataset 114, and processed dataset 116n is generated by utilizing one or more resources 106 to execute a second set of functions on processed dataset 116a.

The processed data repository 112 may store different processed datasets 116 in accordance with different data structures depending on the target use of the particular processed dataset 116. The resource scheduling system 102 may determine a target data structure for a processed dataset 116 based on a mapping of the target use for the processed dataset 116 to the target data structure. Additionally, the resource scheduling system 102 may determine a set of functions to be executed by the resources 106 based on the target data structure for the processed dataset 116. In one example, the target data structure corresponds to the level of granularity of the processed dataset 116. In one example, the resource scheduling system 102 may configure at least a portion of the processed data repository 112 in accordance with a target data structure for a processed dataset to be stored in the processed data repository 112.

The data repository 104 may further include a functions repository 118. The functions repository may include sets of functions 120 that may be executed by the resources 106 to generate processed data. The sets of functions 120 may correspond to different workflows that can be applied to the transaction data to generate processed datasets 116. The sets of functions 120 may correspond to different levels of granularity 122 of the processed datasets 116. The levels of granularity may correspond to different technical processes that utilize processed data at a different level of granularity. The set of functions 120 may be determined based on the level of granularity 122. In one example, function set 120a is mapped to granularity level 122a, and function set 120n is mapped to granularity level 122n. The resource scheduling system 102 may select function set 120a for generating a processed dataset 116 at granularity level 122a. Additionally, or alternatively, the resource scheduling system 102 may select function set 120n for generating a processed dataset 116 at granularity level 122n. The different levels of granularity may correspond to different target uses and/or different target data structures for the processed datasets 116.

In one example, a set of functions 120 may include one or more functions for aggregating a transaction dataset 114. The one or more functions may include operations that are executable by the resources 106 to aggregate the transaction datasets 114 based on one or more aggregation criteria. Aggregating a transaction dataset 114 may include one or more of the following: summation, counting, averaging, grouping, determining maximums, minimums or ranges, determining percentages, or ranking. The one or more aggregation criteria corresponding to a function set may correspond to a particular level of granularity. In one example, function set 120a corresponds to a first set of one or more aggregation criteria and function set 120n corresponds to a second set of one or more aggregation criteria. The first set of one or more aggregation criteria corresponds to a first granularity level 122a and the second set of one or more aggregation criteria corresponds to a second granularity level 122n.

In one example, a set of functions 120 may include one or more functions for disaggregating a transaction dataset 114. The one or more functions may include operations that are executable by the resources 106 to disaggregate the transaction datasets 114 based on one or more disaggregation criteria. Disaggregating a transaction dataset 114 may include one or more of the following: reverse aggregation, drilling down, data splitting, interpolation, or sampling. Additionally, or alternatively, the disaggregation may include combining data from different transaction datasets. The one or more disaggregation criteria corresponding to a function set may correspond to a particular level of granularity. In one example, function set 120a corresponds to a first set of one or more disaggregation criteria and function set 120n corresponds to a second set of one or more disaggregation criteria. The first set of one or more disaggregation criteria corresponds to a first granularity level 122a and the second set of one or more disaggregation criteria corresponds to a second granularity level 122n.

The aggregation criteria and/or the disaggregation criteria may include one or more of the following: time period, transaction, transaction type, transaction status, transaction size, contract, contract type, contract status, account, account type, account status, customer, customer type, vendor, vendor type, product, product type, service, service type, asset, asset type, liability, liability type, technical process, technical process type, market, market type, location, location type, geographic area, facility, facility type, project, project type, instrument, instrument type, current assets, long-term assets, current liabilities, long-term liabilities, equity, retained earnings, sales, interest income, dividends, cost of goods sold, operating expenses, gains, losses, or depreciation, as well as combinations of these. In one example, a first set of aggregation criteria may correspond to one or more categories of a general ledger, and a second set of aggregation criteria may correspond to one or more categories of a subledger, such as an instrument ledger. Additionally, or alternatively, a first set of disaggregation criteria may correspond to one or more categories of a general ledger, and a second set of disaggregation criteria may correspond to one or more categories of a subledger, such as an instrument ledger.

In one or more embodiments, the data repository 104 is any type of storage unit and/or device (e.g., a file system, database, collection of tables, or any other storage mechanism) for storing data. Further, the data repository 104 may include multiple different storage units and/or devices. The multiple different storage units and/or devices may or may not be of the same type or located at the same physical site. Further, the data repository 104 may be implemented or executed on the same computing system as the resource scheduling system 102. Additionally, or alternatively, the data repository 104 may be implemented or executed on a computing system separate from the resource scheduling system 102. The data repository 104 may be communicatively coupled to the resource scheduling system 102 via a direct connection or via a network. The transaction data repository 110, the processed data repository 112, and the functions repository 118 may represent aspects of the same or different storage units and/or devices. Information describing the transaction datasets 114 and/or the processed datasets 116 may be implemented across any of components within the system 100. Additionally, or alternatively, information describing the sets of functions 120 and the levels of granularity 122 may be implemented across any of components within the system 100. However, this information is illustrated within the data repository 104 for purposes of clarity and explanation.

### B. Example Resource Scheduling System.

Referring further to FIG. 1, in one or more embodiments, the resource scheduling system 102 includes one or more of the following: a function selection module 124, a resource utilization module 126, a scheduling module 128, or an execution engine 130.

The function selection module 124 selects sets of functions 120 from the functions repository 118 to be executed upon the transaction data. The set of functions 120 may correspond to a workflow selected for the transaction data. The function selection module 124 may determine one or more workflows for the transaction data based on input parameters, contextual cues, metadata associated with the transaction data, and/or predefined criteria or conditions. A workflow selected for the transaction data may include a workflow for aggregating transaction data and/or a workflow for disaggregating transaction data. The function selection module 124 may determine a level of granularity for applying the workflow to the transaction data. Additionally, the function selection module may determine sets of functions to be executed upon the transaction data. The sets of functions may correspond to workflow selected for the transaction data. The function selection module 124 may select the sets of functions 120 based on characteristics of the transaction data and/or based on a target use for processed datasets 116 generated by applying the selected sets of functions to the transaction data. Additionally, or alternatively, the function selection module 124 may select sets of functions 120 based on the level of granularity 122 for the processed datasets 116. The function selection module 124 may determine characteristics of transaction data through one or more data analysis processes such as data profiling, statistical analysis, or execution of machine learning algorithms. Additionally, or alternatively, the function selection module 124 may select one or more functions based on input parameters, contextual cues, metadata associated with the transaction data, and/or predefined criteria or conditions. The input parameters or predefined criteria or conditions may include an indication of the target use for the processed datasets 116 and/or the level of granularity 122. In one example, the function selection module 124 may determine a set of functions to be applied to the transaction data at different corresponding levels of granularity 122. Additionally, or alternatively, the function selection module 124 may determine the different corresponding levels of granularity 122 based on the characteristics of the transaction data and/or a target use for the processed datasets 116.

The resource utilization module 126 determines resource utilization requirements and execution sequences corresponding to execution of functions 120 selected by the function selection module 124. Additionally, or alternatively, the resource utilization module 126 determines availability of resources 106 for executing the sets of functions 120 on the transaction data. The resource utilization module 126 may determine the resource utilization requirements based on the functions 120 to be executed upon the transaction data. Additionally, or alternatively, the resource utilization module 126 may determine the resource utilization requirements by analyzing characteristics of the transaction data. The characteristics of the transaction data include on one or more of the following: volume of data, velocity of the data, dimensionality of data, variety of data, variability of the data, a structure of the data or whether the data is unstructured, time requirements for performing or completing processing of the data, relationship dependencies between variables or features within the data, or processing dependencies between functions executed upon the data, as well as combinations of these. The resource utilization module 126 may determine the execution sequences corresponding to execution of the selected functions 120 based on one or more characteristics of the transaction data. Additionally, or alternatively, the resource utilization module 126 may determine the execution sequences based on one or more of the following: task dependencies, data flow analysis, parallel processing requirements, or sequential processing requirements, as combinations of these.

The resource utilization requirements may include processing requirements. In one example, the resource utilization module 126 may determine parallel processing requirements corresponding to the set of functions 120 to be applied to the transaction data at the different corresponding levels of granularity. The parallel processing requirements may be based on dependencies between operations executed on the transaction data at the different levels of granularity. Additionally, or alternatively, the parallel processing requirement may depend on characteristics of the transaction data and/or a target use of the transaction data. Further, the resource utilization module 126 may determine an execution order corresponding to the set of functions 120 based on the resource utilization requirements such as the parallel processing requirements.

The resource utilization module 126 may determine the availability of the resources 106 based on scheduled or predicted utilization of the resources 106 for executing functions 120 on the transaction data and/or scheduled or predicted utilization of the resources 106 for other operations. The resource utilization module 126 may determine the availability of the resources for various time periods and/or for various utilization scenarios for the resources 106. The resource utilization module 126 may determine the availability of the resources 106 based on system monitoring data pertaining to current, scheduled, or predicted utilization of the resources 106. In one example, the resource utilization module 126 may compare the availability of the resources 106 to the resource utilization requirements. Utilization of the resources 106 may be based on the availability exceeding the resource utilization requirements. Additionally, or alternatively, the resource utilization module may allocate additional resources 106 when the resource utilization requirements meet an availability threshold.

In one example, the resource utilization module 126 may utilize one or more machine learning models to determine the resource utilization requirements and/or the execution sequence corresponding to execution of a particular set of functions 120 on the data. Additionally, or alternatively, the resource utilization module 126 may utilize one or more machine learning models to determine the availability the resources 106, for example, for various time periods and/or utilization scenarios.

The scheduling module 128 schedules utilization of the resources 106. The utilization of the resources 106 may be scheduled for executing the functions 120 selected by the function selection module 124 and/or for other operations. The scheduling module 128 may generate one or more schedules for utilization of the resources 106. The one or more schedules may correspond to different time periods and/or utilization scenarios. The schedules may be based on resource utilization requirements, execution sequences, and/or resource availability, for example, as determined by the resource utilization module 126. Additionally, or alternatively, the scheduling module 128 may modify schedules based on changing conditions, such as changes to the resource utilization requirements, execution sequences, and/or resource availability. In one example, the scheduling module 128 may schedule deployment and/or utilization of resources 106 in accordance with a service level agreement that specifies performance, availability, and/or reliability requirements. The scheduling module 128 may allocate resources 106 to ensure that workloads meet applicable service level agreements while efficiently utilizing the resources 106.

The execution engine 130 communicates with the resources 106 to cause the resources to execute the sets of functions 120 on the transaction data and/or to execute other operations pertaining to execution of the sets of functions 120 on the transaction data. The execution engine 130 may transmit instructions to the resources 106 to cause the resources to perform operations. The instructions may identify transaction datasets 114, sets of functions 120, and/or schedules for executing the functions 120 on the transaction datasets 114.

### C. Example Machine Learning Models.

Referring further to FIG. 1, in one example, the resource scheduling system 102 includes at least one machine learning model 132. The resource scheduling system 102 may utilize a machine learning model to predict utilization of resources 106, resource utilization requirements, and/or availability of resources 106. Additionally, or alternatively, the resource scheduling system 102 may utilize a machine learning model to generate resource utilization schedules for utilizing the resources 106 in accordance with different scenarios. The different scenarios may correspond to different workflows, different sets of functions, and/or different levels of granularity. A machine learning algorithm 134 may include one or more machine learning algorithms 134, such as supervised algorithms and/or unsupervised algorithms. Various types of algorithms may be used, such as linear regression, logistic regression, linear discriminant analysis, classification and regression trees, naïve Bayes, k-nearest neighbors, learning vector quantization, support vector machine, bagging, and random forest, boosting, backpropagation, and/or clustering. In addition, or in the alternative, to a machine learning model 132, the resource scheduling system 102 may utilize one or more classical models. A classical model may include one or more classical statistical algorithms that rely on a set of assumptions about one or more of the underlying data, the data generating process, or the relationships between the variables. Example classical statistical algorithms may include linear regression, logistic regression, ANOVA (analysis of variance), or hypothesis testing.

In one example, a machine learning algorithm 134 can be iterated to learn a target model f that best maps a set of input variables to an output variable. In particular, a machine learning algorithm 134 may be configured to generate and/or train a machine learning model 132. A machine learning algorithm 134 may be iterated to learn a target model f that best maps a set of input variables to an output variable, using a set of training data. Training data used by a machine learning algorithm 134 may be stored in a training data corpus, for example, in the data repository 104. The training data may include datasets and associated labels. The datasets may be associated with input variables for the target model f. The associated labels may be associated with the output variable of the target model f. The training data may be updated based on, for example, feedback on the accuracy of the current target model f. Updated training data may be fed back into the machine learning algorithm 134, that in turn updates the target model f.

A machine learning algorithm 134 may generate a target model f such that the target model/best fits the datasets of training data to the labels of the training data. Additionally, or alternatively, a machine learning algorithm 134 may generate a target model f such that when the target model f is applied to the datasets of the training data, a maximum number of results determined by the target model f matches the labels of the training data. Different target models may be generated based on different machine learning algorithms 134 and/or different sets of training data.

In one example, as shown in FIG. 1, the resource scheduling system 102 may include a model trainer 136 that utilizes one or more machine learning algorithms 134 to generate and/or train a machine learning model 132. In one example, the model trainer 136 may obtain and/or generate feedback from one or more of the machine learning models 132. The model trainer 136 may train, update, and/or retrain one or more of the machine learning models 132 based at least in part on the feedback. The feedback may correspond to one or more outputs of at least one machine learning model 132. In one example, the model trainer 136 may obtain a plurality of training datasets. The model trainer 136 may train a machine learning model 132 utilized by the resource scheduling system 102 based at least in part on the plurality of training datasets.

The training datasets may include datasets from the data repository 104, such as transaction datasets 114 and/or processed datasets 116. In one example, the training data may include outputs from one or more of the machine learning models 132. For example, a machine learning model 132 may be iteratively trained and/or re-trained based at least in part on outputs generated by one or more of the machine learning models 132. A machine learning model 132 may be iteratively improved over time as additional datasets are analyzed by the machine learning model 132 to produce additional outputs, and the machine learning model 132 is iteratively trained or re-trained based on the additional outputs.

In one example, the training data may include one or more initial supervised learning datasets. The model trainer 136 may train a machine learning model 132 based at least in part on the one or more initial supervised learning datasets. In one example, the training data may include one or more subsequent supervised learning datasets. The model trainer 136 may update or retrain the machine learning model 132 based on one or more subsequent supervised learning datasets. The one or more subsequent supervised learning datasets may be generated based at least in part on feedback corresponding to one or more outputs of the machine learning model 132.

### D. Example System Interfaces.

Referring again to FIG. 1, the system 100 may include a user device interface 138 communicatively coupled or couplable with the resource scheduling system 102. The user device interface 138 may include hardware and/or software configured to facilitate interactions between a user and various aspects of the system 100. The user device interface 138 may render user interface elements and receive input via user interface elements. For example, the user device interface 138 may display outputs generated by the resource scheduling system 102.

Additionally, or in the alternative, the user device interface 138 may be configured to select datasets as inputs to the resource scheduling system 102. Examples of interfaces include a GUI, a command line interface (CLI), a haptic interface, or a voice command interface. Examples of user interface elements include checkboxes, radio buttons, dropdown lists, list boxes, buttons, toggles, text fields, date and time selectors, command lines, sliders, pages, or forms. Any one or more of these interfaces or interface elements may be utilized by the user device interface 138.

In an embodiment, different components of a user device interface 138 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, the user device interface 138 may be specified in one or more other languages, such as Java, C, or C++.

Referring again to FIG. 1, the system 100 may include at least one communications interface 140 communicatively coupled or couplable with the resource scheduling system 102, the data repository 104, and/or the user device interface 138. The at least one communications interface 140 may include hardware and/or software configured to transmit data between respective components of the system 100 and/or to transmit data to and/or from the system 100. For example, a communications interface 140 may transmit and/or receive data between and/or among one or more of: the resource scheduling system 102, and the data repository 104, or the user device interface 138.

### 3. Determining Functions for Processing Transaction Data

Referring to FIG. 2, example operations 200 pertaining to determining functions for processing data transactions are further described. One or more operations 200 described with reference to FIG. 2 may be modified, combined, rearranged, or omitted. Accordingly, the particular sequence of operations 200 described with reference to FIG. 2 should not be construed as limiting the scope of one or more embodiments. In one example, the operations 200 may be performed by the one or more components of the system described with reference to FIG. 1.

As shown in FIG. 2, the operations 200 include accessing transaction data (Operation 202). The transaction data may be accessed from a data repository by a resource scheduling system. Additionally, or alternatively, the resource scheduling system may access the transaction data from one or more data sources. The resource scheduling system may access the transaction data by generating queries or requests to the data repository. The resource scheduling system may access the transaction data to generate processed data from the transaction data. In one example, a system receives transaction data in real-time. In one example, the system receives the transaction data at different levels of granularity. The system may receive the transaction data from different data sources. The different data sources may provide transaction data at different levels of granularity. The transaction data may be received at a uniform level of granularity or at different levels of granularity.

In one example, the resource scheduling system determines a workflow to be applied to the transaction data (Operation 204). The workflow includes a set of operations for subjecting the transaction data to a target use. The workflow may be determined based on one or more of the following: input parameters, contextual cues, metadata associated with the transaction data, or predefined criteria or conditions. In one example, a workflow includes aggregating transaction data or disaggregating transaction data to generate processed datasets. Additionally, or alternatively, a workflow may include selecting transaction datasets from a data corpus, for example, for aggregating or disaggregating. Additionally, or alternatively, a workflow may include utilizing processed datasets in downstream processes. In one example, a workflow may include a plurality of downstream processes that utilize processed datasets at different levels of granularity. Additionally, a workflow may include aggregating the transaction data at the different levels of granularity that the processed datasets are utilized in the plurality of downstream processes.

In one example, the resource scheduling system determines a level of granularity for applying the workflow to the transaction data to generate processed dataset. (Operation 206). The level of granularity for generating the processed dataset may correspond to different target uses, such as in different downstream processes, that utilize processed dataset at a different level of granularity. The resource scheduling system may determine the level of granularity based on a target use for the processed dataset, such as a downstream process that will utilize the processed dataset. The level of granularity may be determined based on one or more of the following: input parameters, contextual cues, metadata associated with the transaction data, or predefined criteria or conditions.

In one example, the resource scheduling system determines a set of functions to be executed upon the transaction data (Operation 208). The set of functions may correspond to the workflow selected for the transaction data at operation 204. The set of functions may be selected based on the level of granularity determined at operation 206. Additionally, or alternatively, the set of functions may be determined based on characteristics of the transaction data and/or based on a target use for the processed dataset. In one example, workflow W includes aggregating transaction data to generate processed dataset W. The resource scheduling system determines function set W for aggregating the transaction data. Additionally, workflow X includes disaggregating transaction data to generate processed dataset X. The resource scheduling system determines function set X for disaggregating the transaction data. In another example, workflow Y includes aggregating transaction data at a first level of granularity to generate processed dataset Y that has the first level of granularity. The resource scheduling system determines function set Y for aggregating the transaction data. Additionally, workflow Z includes aggregating transaction data at a second level of granularity to generate processed dataset Z that has the second level of granularity. The resource scheduling system determines function set Z for aggregating the transaction data. In yet another example, workflow Q includes receiving transaction data that has R level of granularity, and aggregating the transaction data to generate processed dataset S that has S level of granularity. The resource scheduling system determines function set R for aggregating the transaction data. Additionally, workflow Q includes receiving transaction data that has T level of granularity, and aggregating the transaction data to generate processed dataset U that has U level of granularity. The resource scheduling system determines function set U for aggregating the transaction data.

The resource scheduling system may determine characteristics of the transaction data through one or more data analysis processes such as data profiling, statistical analysis, or execution of machine learning algorithms. Additionally, or alternatively, the resource scheduling system may determine characteristics of the transaction data and/or the set of functions to be applied to the transaction data based on one or more of the following: input parameters, contextual cues, metadata associated with the transaction data, or predefined criteria or conditions.

In one example, the resource scheduling system may determine the set of functions based on a set of aggregation criteria. The aggregation criteria specify how different transaction records should be aggregated to generate aggregated transaction data sets for downstream processing. The aggregation criteria may further specify which attributes to include, and which attributes to omit, in the aggregated transaction data sets. For example, a set of transaction data may include features A-F. The system may determine that a downstream function requires features A and B. Additionally, or alternatively, the aggregation criteria may specify which transaction records to include in an aggregated transaction data set based on the attributes included in the transaction records. For example, the system may determine that a downstream function requires features A-C. The system may omit from the aggregated transaction data set transaction records including features A and B and omitting feature C.

The aggregation criteria may correspond to a particular level of granularity. In one example, the resource scheduling system may determine a set of functions to be applied to transaction data at a first level of granularity and a second level of granularity based on a set of aggregation criteria for aggregating the transaction data at both the first level of granularity and the second level of granularity. The resource scheduling system may determine the aggregation criteria based on characteristics of the transaction data and/or a target use of processed data resulting from aggregating the transaction data. Additionally, or alternatively, resource scheduling system may determine the aggregation criteria through one or more data analysis processes such as data profiling, statistical analysis, or execution of machine learning algorithms. Additionally, or alternatively, the resource scheduling system may determine the aggregation criteria based on one or more of the following: input parameters, contextual cues, metadata associated with the transaction data, or predefined criteria or conditions.

In one example, the resource scheduling system may determine a target use for the transaction data. The resource scheduling system may determine the level of granularity for generating processed data from the transaction data (Operation 206) based on the target use for the transaction data. The resource scheduling system may determine a target use for a set of transaction data based on one or more of the following: input parameters, contextual cues, metadata associated with the transaction data, or predefined criteria or conditions.

In one example, a target use may include generating prediction data. The prediction data may be utilized as an input to a prediction model. The prediction model may generate prediction outputs. The prediction outputs may be utilized as operating inputs for a facility, device, or machine. Additionally, or alternatively, the prediction outputs may be utilized to make operational decisions associated with a facility, device, or machine. A workflow for generating the prediction data may include (a) selecting a random set of transaction entries from a transaction dataset (e.g., 1,000 randomly selected transaction entries) within a predetermined time frame, (b) aggregating the set of transaction entries to generate a processed dataset, (c) providing the processed dataset as an input to a prediction data generation module, and (d) utilizing the prediction data generation module to generate the prediction data from the processed dataset. The prediction data generation module may require that the processed dataset be aggregated at X level of granularity. The resource scheduling system determines X level of granularity for aggregating the transaction data based on the requirement of the prediction generation module. The resource scheduling system determines a set of functions for aggregating the transaction data at X level of granularity.

Additionally, a target use may include generating a report based on a processed dataset. A workflow for generating the report may include (a) selecting a set of transaction data, (b) aggregating the transaction data to generate a processed dataset, and (c) populating fields of a report generation module with the processed dataset to generate the report. The fields of the report generation module may require that the processed dataset be aggregated at Y level of granularity. The resource scheduling system determines Y level of granularity for aggregating the transaction data based on the requirement of the fields of the report generation module. The resource scheduling module determines a set of functions for aggregating the transaction data at Y level of granularity. In one example, a first report may include every transaction record of a particular type. A second report may include an aggregated datasets corresponding to a particular type of transaction records. The transactions of the particular type are determined by content with in the transaction records.

In addition, a target use may include providing a processed dataset to a downstream application that utilizes the processed dataset to generate parameter values for controlling functions of a computing device. A workflow for generating the parameter values may include (a) selecting a set of transaction data, (b) aggregating the transaction data to generate a processed dataset, and (c) providing the processed dataset as an input to the downstream application, and (d) utilizing the downstream application to generate the parameter values from the processed dataset. The downstream application may require that the processed dataset be aggregated at Z level of granularity. The resource scheduling system determines Z level of granularity for aggregating the transaction data based on the requirement of the downstream application. The resource scheduling system determines a set of functions for aggregating the transaction data at Z level of granularity. In one example, the downstream application may generate a first parameter value based on every transaction record of a particular type. The downstream application may generate a second parameter value based on an aggregated datasets corresponding to a particular type of transaction records. The transactions of the particular type are determined by content with in the transaction records.

In one example, the resource scheduling system may configure one or more data repositories in accordance with the target data structure for storage of datasets generated in accordance with the target data structure. In one example, the resource scheduling system may determine a target data structure corresponding to the target use. The target data structure may be determined based on a mapping of the target use to the target data structure and/or a mapping of the target use to the level of granularity. The target data structure may correspond to the level of granularity. In one example, the target use is mapped to the level of granularity, and the level of granularity includes an indication of the target data structure. Additionally, or alternatively, the target data structure may be determined based on the level of granularity. In one example, the level of granularity is mapped to the target use, and the target data structure is mapped to the level of granularity.

In one example, the target data structure may include data fields that correspond to the level of granularity. The data fields of the target data structure may correspond to how the processed datasets stored in the target data structure are divided or categorized. Additionally, or alternatively, the target data structure may reflect one or more basis of categorization of the processed datasets. In one example, determining the level of granularity at operation 206 may include determining how the processed datasets are to be divided or categorized. Additionally, or alternatively, determining the level of granularity at operation 206 may include determining one or more basis of categorization of the processed datasets. An indication as to how the processed datasets are to be divided or categorized and/or an indication as to one or more basis of categorization of the processed datasets may be determined based on one or more of the following: input parameters, contextual cues, metadata associated with the transaction data, or predefined criteria or conditions. resource scheduling system may determine. The resource scheduling system may determine the target data structure from the same or different source as utilized to determine the level of granularity at operation 206. In one example, a first target data structure corresponding to a first level of granularity may include features A-C. A second target data structure corresponding to a second level of granularity may include features A and B and may omit feature C. Yet another may include feature B and omit features A and C.

The transaction data may be processed at one or more different levels of granularity. The resource scheduling system may determine whether the transaction data is to be processed at an additional level of granularity (Operation 210), and if so, the resource scheduling system may determine the additional level of granularity (Operation 206) and the set of functions to be applied to the transaction data at the additional level of granularity (Operation 208).

Upon having determined a set of functions to be applied to the transaction data at different corresponding levels of granularity, the resource scheduling system determines a set of parallel processing requirements corresponding to the set of functions (Operation 212) and an execution order corresponding to the set of functions (Operation 214). In one example, the resource scheduling system may determine a set of parallel processing requirements and a set of sequential processing requirements. The resource scheduling system may determine the parallel processing requirements and/or the sequential processing requirements based on dependencies between operations executed on the transaction data at the different levels of granularity. Additionally, or alternatively, the resource scheduling system may determine the parallel processing requirements and/or the sequential processing requirements based on characteristics of the transaction data and/or a target use of the transaction data. In one example, the parallel processing requirements and/or the sequential processing requirements are based at least in part on a target data structure for one or more datasets generated by executing the set of functions on the transaction data.

According to one example, the resource scheduling system receives a set of transaction data. The resource scheduling system determines that the set of transaction data will be processed by one set of functions requiring one level of granularity of the data and another set of functions requiring another level of granularity for the transaction data. The resource scheduling system identifies characteristics of the different sets of transaction data and the different sets of functions to be applied to the different sets of transaction data to determine parallel processing requirements for (a) generating different transaction data sets at different levels of granularity, and (b) performing the different sets of functions on the different transaction data sets.

For example, the resource scheduling system may identify the following characteristics: a place, in a scheduling order, in which different subsets of the transaction data may be processed by the different sets of functions; dependencies, among functions executed in a processing system, on the different transaction data sets; an estimate of the time required to generate the different transaction data sets at the different levels of granularity; an estimate of the time required to execute the functions on the different data sets at the different levels of granularity; and a size of the transaction data and the different transaction data sets; types of data included in the transaction data and the types of data included in the different transaction data sets. Based on the characteristics of the different sets of transaction data and the different functions to be applied to the different sets of transaction data, the resource scheduling system determines the parallel processing requirements for (a) generating different transaction data sets at different levels of granularity, and (b) performing the different sets of functions on the different transaction data sets.

In one example, the resource scheduling system determines dependencies between operations executed on the transaction data at the different levels of granularity. The dependencies may include dependency chains in which an output of one function serves as an input of another function. Additionally, or in the alternative, the dependencies may include data reconciliation functions that are utilized to reconcile processed datasets generated at different levels of granularity back to the source transaction datasets utilized to generate the processed datasets. The reconciliation functions may include operations configured to correct for one or of the following: aggregation bias dependencies, data consistency dependencies, hierarchical relationships, sampling biases, temporal dependencies, spatial dependencies, or statistical dependencies. Based on the dependencies, the resource scheduling system determines the parallel processing requirements for (a) generating different transaction data sets at different levels of granularity, and (b) performing the different sets of functions on the different transaction data sets.

The resource scheduling system may determine the execution order based on parallel processing requirements and/or the sequential processing requirements. Additionally, or alternatively, the resource scheduling system may determine the execution order based on task dependencies or data flow analysis.

Upon having determined the execution order corresponding to the set of functions, the resource scheduling system schedules execution of the set of functions (Operation 216). The resource scheduling system may schedule execution of the set of functions in accordance with the execution order determined at operation 214. Additionally, or alternatively, the resource scheduling system may schedule execution of the set of functions based on resource utilization requirements and and/or resource availability. In one example, the resource scheduling system may schedule parallel execution of a first function at a first level of granularity and a second function at a second level of granularity. The parallel execution of the first function and the second function on the transaction data may generate a first dataset that has the first level of granularity and a second dataset that has the second level of granularity.

The resource scheduling system may schedule additional functions for parallel execution based on availability of resources and/or resource requirements for parallel execution. In one example, the resource scheduling system may schedule an additional function for parallel execution when a resource availability exceeds a resource requirement for the parallel execution. The resource availability may be compared to resource requirement for the parallel execution of functions that are already scheduled for parallel execution. The resource scheduling system may schedule execution an additional function in parallel with the functions that are already scheduled for parallel execution. The additional function may be selected from a set of functions that are ordered subsequent in the execution order relative to the functions that are already scheduled for parallel execution.

In one example, the resource scheduling system may allocate additional resources for parallel execution in response to determining that a resource availability is less than a resource requirement, for example, for meeting a parallel execution requirement. Additionally, or alternatively, the resource scheduling system may reschedule at least a portion of an execution order in response to determining that the resource availability is less than the resource requirement. The resource scheduling system may allocation additional resources and/or reschedule at least a portion of the execution order in response to determining that parallel execution of a first function and a second function is scheduled for a period when the resource availability is less than a resource requirement for parallel execution of the first function and the second function. Subsequent to rescheduling the execution order, the resource availability may exceed the resource requirement for execution of the first function and the second function.

Upon having scheduled execution of the set of functions, the resource scheduling system transmits instructions to one or more resources for execution of the set of functions (Operation 218). The instructions may cause the resources to execute the set of functions on the transaction data. The instructions may identify transaction datasets to be processed by the resources. Additionally, or alternatively, the instructions may identify the set of functions to be executed on the transaction data. Additionally, or alternatively, the instructions may identify a schedule for executing the set of functions on the transaction data.

In one example, in response to the instructions for the resource scheduling system, the resources generate a first dataset that has a first level of granularity and a second dataset that has a second level of granularity. The first dataset and the second dataset may be stored in a data repository, for example, as a processed dataset in the processed data repository. The first dataset may correspond to a first target use and the second dataset may correspond to a second target use. The first dataset may be stored accordance with a first target data structure that corresponds to the first target use, and the second dataset be stored accordance with a second target data structure that corresponds to the second target use. In one example, the first target use may correspond to a first technical process and the second target use may correspond to a second technical process. Additionally, or alternatively, the first dataset may be utilized as an input for generating the second dataset. In one example, the resources may generate the first dataset by aggregating transaction data at a first level of granularity, and the resources may generate the second dataset by aggregating the first dataset at a second level of granularity. The first dataset may be aggregated according to a first set of aggregation criteria and the second dataset may be aggregated according to a second set of aggregation criteria.

### 4. Example Embodiment

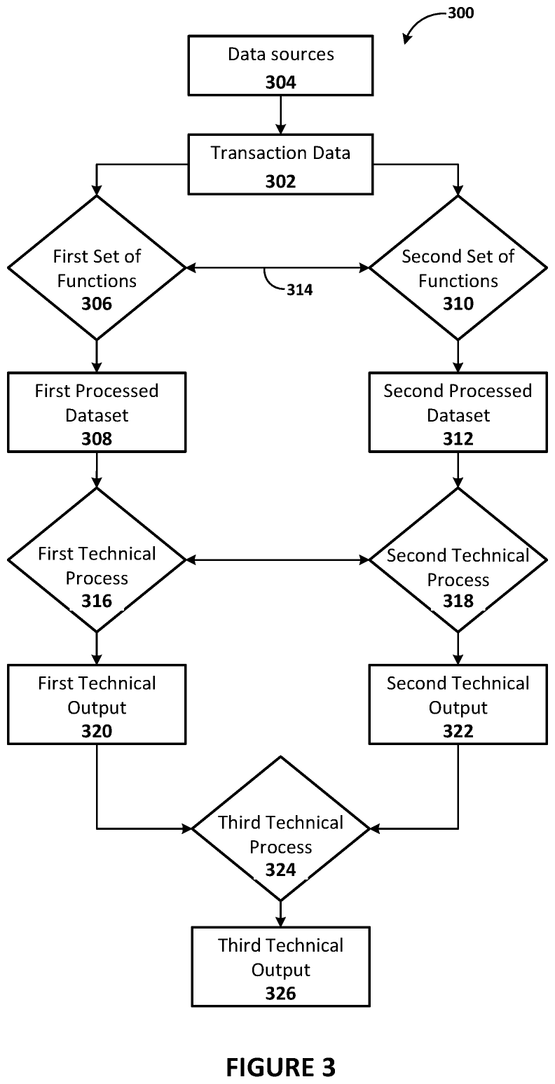

Referring to FIG. 3, a detailed example is described for purposes of clarity. Components and/or operations described with reference to FIG. 3 should be understood as one specific example that may not be applicable to certain embodiments. Accordingly, components and/or operations described with reference to FIG. 3 should not be construed as limiting the scope of any of the claims.

As shown in FIG. 3, a system 300 receives transaction data 302 from a set of data sources 304. The transaction data 302 may represent events associated with technical processes or operations. The system 300 may receive the transaction data 302 from and external partners, customers, or vendors.

In one example, the transaction data may include operational data associated with various facilities located at various geographic areas. Additionally, or alternatively, the transaction data may include operational data associated with a fleet of devices or machines deployed to various locations. The fleet of devices or machines may be mobile or stationary. The transaction data may represent operations or occurrences of events associated with the facilities, devices, or machines. The transaction data may be event-based, time-based, spatially-based, and/or category-based. In one example, the transaction data may include source data for executing technical operations one or more of the following: purchase orders, invoices, sales orders, inventory transactions, receipts, expenses, shipping transactions, contract transactions, financial transactions, securities transactions, travel itineraries, healthcare transactions, point-of-sale transactions, subscription-based transactions, transportation transactions, or government transactions, as well as combinations of these.

The system 300 may receive the transaction data 302 from one or more data sources 304, such as internal or external systems or databases. The system 300 may receive the transaction data 302 through various mechanisms such as APIs, database connections, file transfers, or message queues. In one example, the system 300 may obtain transaction data 302 from various facilities, devices, or machines at various locations. In one example, the system 300 may obtain transaction data 302 from vehicles, such as delivery vehicles, agricultural machinery, drones, industrial equipment, rental cars, marine vessels, or public transportation vehicles. In one example, the system 300 may obtain transaction data 302 from an e-commerce platform through API calls to payment gateways. In one example, the system 300 may obtain transaction data 302 from a financial institution directly from one or more databases operated by the institution. Other examples of transaction data sources include web services, IoT devices, sensors, logs files, social media platforms, or data feeds.

The system 300 may process the transaction data 302 according to a first set of functions 306 to generate a first processed dataset 308. Additionally, or alternatively, the system 300 may process the transaction data 302 according to a second set of functions 310 to generate a second processed dataset 312. The first set of functions 306 and the second set of functions 310 may include parallel processing requirements 314. The system 300 may utilize the first processed dataset 308 in a first technical process 316. Additionally, or alternatively, the system 300 may utilize the second processed dataset 312 in a second technical process 318. The first technical process 316 may include generating a first technical output 320 based on the first processed dataset 308. Additionally, or alternatively, the second technical process 318 may include generating a second technical output 322 based on the second processed dataset 312. The first technical process 316 may utilize the first processed dataset 308 at a first level of granularity, and the second technical process 318 may utilize the second processed dataset 312 at a second level of granularity. In one example, the first technical process 316 may utilize or depend upon the second technical process 318. Additionally, or alternatively, the second technical process 318 may utilize or depend upon the first technical process 316. In one example, the first technical process 316 may include providing the first technical output 320 to a first recipient. The first recipient may include a first technical unit, a first stakeholder, a first customer, or a first vendor. Additionally, or alternatively, the second technical process 318 may include providing the second technical output 322 to a second recipient. The second recipient may include a second technical unit, a second stakeholder, a second customer, or a second vendor.

In one example, the first processed dataset 308 may include an operational input for a particular facility, device, and/or machine. The first technical process 316 may include producing a product or service. The first processed dataset 308 may be utilized by the particular facility, device, and/or machine to control the first technical output 320. In one example, the second processed dataset 312 may include an operational input for a group of facilities, devices, and/or machines. The second technical process 318 may represent a set of processes of the group of facilities, devices, or machines. The second technical process 318 may include producing a product or service that depends on the collective operations of the group of facilities, devices, or machines. The second processed dataset 312 may be utilized control operational outputs of the group of group of facilities, devices, and/or machines collectively as a group. In one example, the first technical output 320 may correspond to a first facility, device, or machine, and the second technical output 322 may correspond to a group of facilities, devices, or machines that includes the first facility, device, or machine.

In one example, the system 300 may reconcile the first technical output 320 and the second technical output 322 to the same set of transaction data 302. Additionally, or alternatively, the system 300 may reconcile the first technical output 320 and the second technical output 322 against one another. Because the first technical output 320 and the second technical output 322 trace back to the same source of transaction data 302, the first technical process 316 and the second technical process 318 may operate in concert with one another, including generating respective outputs that are consistent with one another. In one example, the first technical process 316 may include product-level operations, and the second technical process 318 may include instrument-level operations. Additionally, or alternatively, the first technical process 316 may include accounting-level operations, and the second technical process 318 may include instrument-level operations or product-level operations. In one example, the system 300 may reconcile a first technical output 320 corresponding to product-level operations against a second technical output 322 corresponding to instrument-level operations. Additionally, or alternatively, the system 300 may reconcile a first technical output 320 corresponding to accounting-level operations against a second technical output 322 corresponding to instrument-level operations or product-level operations.

In one example, the system 300 may utilize the first technical output 320 and the second technical output 322 in a third technical process 324. The third technical process 324 may generate a third technical output 326 based on the first technical output 320 and the second technical output 322. The third technical process 324 may include reconciling the first technical output 320 against the second technical output 322 to generate a third technical output 326. The third technical output may include a reconciliation of the first technical output 320 against the second technical output 322. In one example, the third technical process 324 may include providing the third technical output 326 to a technical unit, a stakeholder, a customer, or a vendor.

FIG. 3 illustrates an example embodiment in which a system determines parallel processing requirements for a set of transaction data representing technical events. However, embodiments are not limited to the example illustrated in FIG. 3. According to another example embodiment a system monitors devices in a cloud environment with sensors and software tracking applications. A database system receives transaction data representing data transmissions within the system and the status of devices in the cloud environment. Transaction data received from one device monitor represents the device at one level of granularity represented by attributes A-C (such as temperature, utilization time, and error status). Transactions received from another device monitor represent the other device at another level of granularity represented by attributes A, B, D, and E (such as temperature, utilization time, data packets received, and data packets transmitted). For a set of transaction data, the system determines downstream functions to be applied to the transaction data. The system determines that the downstream functions include presenting, in near real-time (e.g., as data is received, delayed by the time required to process the data and perform functions to present the data), system status data in a graphical user interface (GUI). The system determines the downstream functions further include predicting future computing resource demand within the system. The system determines the granularity required for the different functions. The system determines that one function requires values for attributes A and B. The system determines that another function requires values for attributes D and E.

Based on determining the level of granularity required to perform the different functions, the system determines the parallel processing requirements, including processing resource requirements and memory requirements, required to (a) generate two different transaction data sets at two levels of granularity, and (b) to execute in parallel the status presentation function in the GUI and the prediction function.

In determining parallel processing requirements, the system may determine that a set of intermediate operations are required to generate one of the transaction data sets. For example, if one transaction data set requires values for attributes A and B, but a set of transaction records omits a value for attribute A, the system may identify an estimation operation required to generate a set of transaction records that include estimated values for attribute A.

In addition, determining the parallel processing requirements may include determining processing requirements to aggregate a first subset of transaction records into a first transaction data set characterized by a first level of granularity and to aggregate a second subset of transaction records into a second transaction data set characterized by a second level of granularity. The first subset and the second subset may overlap, such that an intersecting set of transaction records is included in both transaction data sets characterized by different levels of granularity.

Based on the parallel processing requirements, the system allocates processors, processing threads, I/O resources, and memory to perform the functions in parallel. The system performs a parallel processing operation to (a) retrieve transaction data from the database, (b) generate a first data set at a first level of granularity from a first subset of the transaction data, and (c) generate a second data set at a second level of granularity from a second subset of the transaction data. The system may further perform parallel processing to (a) present system status data in the GUI, and (b) apply the second data set to a machine learning model to generate a prediction for a future processing resource demand within the system.

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Microservice Applications

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, that are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

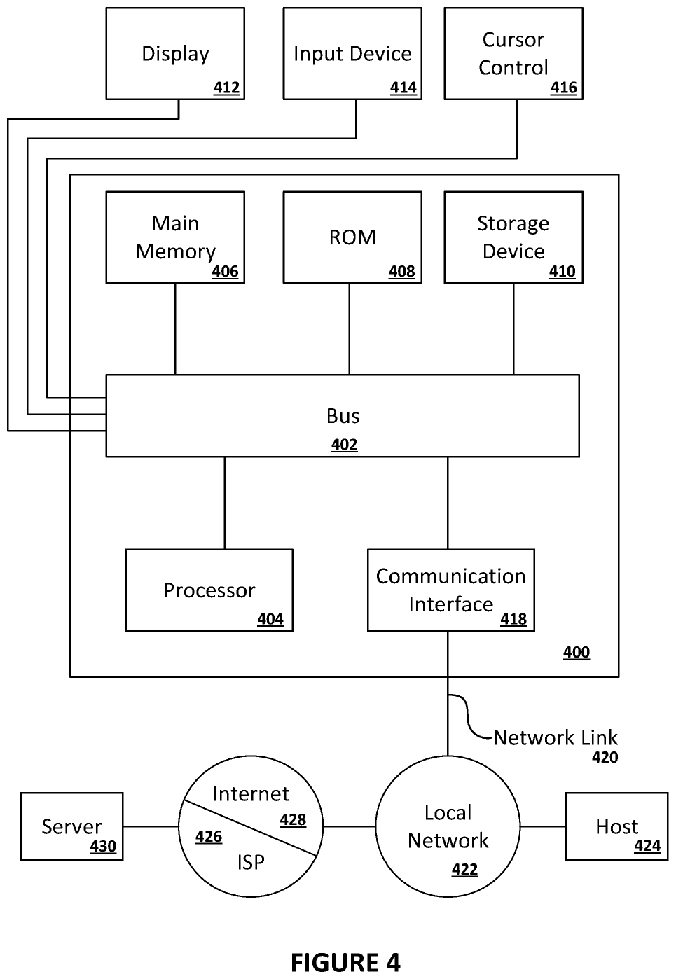

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid-State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic that in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, that carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer-readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
accessing transaction data associated with a plurality of transactions;
determining, based on characteristics of the transaction data, a set of functions to be applied to the transaction data at different corresponding levels of granularity;
determining, based on the set of functions to be applied to the transaction data at different levels of granularity, a set of parallel processing requirements corresponding to the set of functions;
determining, based at least in part on the set of parallel processing requirements, an execution order corresponding to the set of functions;
scheduling parallel execution of (a) a first function, of the set of functions, on the transaction data at a first level of granularity, of the different levels of granularity, to generate a first dataset comprising the first level of granularity and (b) a second function, of the set of functions, on the transaction data at a second level of granularity, of the different levels of granularity, to generate a second dataset comprising the second level of granularity;
wherein the method is performed by at least one device including a hardware processor.

2. The method of claim 1, further comprising:
determining that a resource availability exceeds a resource requirement for the parallel execution of the first function and the second function;
identifying a third function ordered subsequent to the first function and the second function in the execution order;
scheduling execution of the third function in parallel with the first function and the second function.

3. The method of claim 1, further comprising:
determining that a resource availability is less than a resource requirement for the parallel execution of the first function and the second function;
allocating additional resources for the parallel execution of the first function and the second function.

4. The method of claim 1, further comprising:
generating the second dataset comprising the second level of granularity at least by aggregating the first dataset comprising the first level of granularity, wherein the set of functions is determined based on a set of aggregation criteria for aggregating the transaction data at both the first level of granularity and the second level of granularity.

5. The method of claim 1, further comprising:
determining a target use for the transaction data;
determining a target data structure corresponding to the target use based on a mapping of the target use to the target data structure, wherein the target data structure corresponds to the first level of granularity;
wherein determining the set of parallel processing requirements comprises:
determining, based at least in part on the target data structure, a first parallel processing requirement corresponding to generating the first dataset in accordance with the target data structure.

6. The method of claim 5, further comprising:
configuring a first data repository in accordance with the target data structure;
generating the first dataset in accordance with the target data structure;
storing the first dataset in the first data repository.

7. The method of claim 1, further comprising:
determining that parallel execution of the first function and the second function is scheduled for a period when a resource availability is less than a resource requirement for parallel execution of the first function and the second function;
rescheduling the execution order to position execution of at least a portion of the second function subsequent to at least a portion of the first function,
wherein subsequent to rescheduling the execution order, the resource availability exceeds the resource requirement for execution of the first function and the second function.

8. One or more non-transitory computer-readable media storing instructions that, when executed by one or more hardware processors, cause performance of operations comprising:
accessing transaction data associated with a plurality of transactions;
determining, based on characteristics of the transaction data, a set of functions to be applied to the transaction data at different corresponding levels of granularity;
determining, based on the set of functions to be applied to the transaction data at different levels of granularity, a set of parallel processing requirements corresponding to the set of functions;
determining, based at least in part on the set of parallel processing requirements, an execution order corresponding to the set of functions;
scheduling parallel execution of (a) a first function, of the set of functions, on the transaction data at a first level of granularity, of the different levels of granularity, to generate a first dataset comprising the first level of granularity and (b) a second function, of the set of functions, on the transaction data at a second level of granularity, of the different levels of granularity, to generate a second dataset comprising the second level of granularity.

9. The one or more non-transitory computer-readable media of claim 8, wherein the operations further comprise:
determining that a resource availability exceeds a resource requirement for the parallel execution of the first function and the second function;
identifying a third function ordered subsequent to the first function and the second function in the execution order;
scheduling execution of the third function in parallel with the first function and the second function.

10. The one or more non-transitory computer-readable media of claim 8, wherein the operations further comprise:
determining that a resource availability is less than a resource requirement for the parallel execution of the first function and the second function;
allocating additional resources for the parallel execution of the first function and the second function.

11. The one or more non-transitory computer-readable media of claim 8, wherein the operations further comprise:
generating the second dataset comprising the second level of granularity at least by aggregating the first dataset comprising the first level of granularity, wherein the set of functions is determined based on a set of aggregation criteria for aggregating the transaction data at both the first level of granularity and the second level of granularity.

12. The one or more non-transitory computer-readable media of claim 8, wherein the operations further comprise:
determining a first target use for the transaction data;
determining a target data structure corresponding to the first target use based on a mapping of the first target use to the target data structure, wherein the target data structure corresponds to the first level of granularity;
wherein determining the set of parallel processing requirements comprises:
determining, based at least in part on the target data structure, a first parallel processing requirement corresponding to generating the first dataset in accordance with the target data structure.

13. The one or more non-transitory computer-readable media of claim 12, wherein the operations further comprise:
configuring a first data repository in accordance with the target data structure;
generating the first dataset in accordance with the target data structure;
storing the first dataset in the first data repository.

14. The one or more non-transitory computer-readable media of claim 8, wherein the operations further comprise:
determining that parallel execution of the first function and the second function is scheduled for a period when a resource availability is less than a resource requirement for parallel execution of the first function and the second function;
rescheduling the execution order to position execution of at least a portion of the second function subsequent to at least a portion of the first function,
wherein subsequent to rescheduling the execution order, the resource availability exceeds the resource requirement for execution of the first function and the second function.

15. A system comprising:
at least one device including a hardware processor;
the system being configured to perform operations comprising:
accessing transaction data associated with a plurality of transactions;
determining, based on characteristics of the transaction data, a set of functions to be applied to the transaction data at different corresponding levels of granularity;
determining, based on the set of functions to be applied to the transaction data at different levels of granularity, a set of parallel processing requirements corresponding to the set of functions;
determining, based at least in part on the set of parallel processing requirements, an execution order corresponding to the set of functions;
scheduling parallel execution of (a) a first function, of the set of functions, on the transaction data at a first level of granularity, of the different levels of granularity, to generate a first dataset comprising the first level of granularity and (b) a second function, of the set of functions, on the transaction data at a second level of granularity, of the different levels of granularity, to generate a second dataset comprising the second level of granularity.

16. The system of claim 15, wherein the operations further comprise:
determining that a resource availability exceeds a resource requirement for the parallel execution of the first function and the second function;
identifying a third function ordered subsequent to the first function and the second function in the execution order;
scheduling execution of the third function in parallel with the first function and the second function.

17. The system of claim 15, wherein the operations further comprise:
determining that a resource availability is less than a resource requirement for the parallel execution of the first function and the second function;
allocating additional resources for the parallel execution of the first function and the second function.

18. The system of claim 15, wherein the operations further comprise:
generating the second dataset comprising the second level of granularity at least by aggregating the first dataset comprising the first level of granularity, wherein the set of functions is determined based on a set of aggregation criteria for aggregating the transaction data at both the first level of granularity and the second level of granularity.

19. The system of claim 15, wherein the operations further comprise:
determining a first target use for the transaction data;
determining a target data structure corresponding to the first target use based on a mapping of the first target use to the target data structure, wherein the target data structure corresponds to the first level of granularity;
wherein determining the set of parallel processing requirements comprises:
determining, based at least in part on the target data structure, a first parallel processing requirement corresponding to generating the first dataset in accordance with the target data structure.

20. The system of claim 15, wherein the operations further comprise:
determining that parallel execution of the first function and the second function is scheduled for a period when a resource availability is less than a resource requirement for parallel execution of the first function and the second function;
rescheduling the execution order to position execution of at least a portion of the second function subsequent to at least a portion of the first function,
wherein subsequent to rescheduling the execution order, the resource availability exceeds the resource requirement for execution of the first function and the second function.
